(19) United States
(12) Patent Application Publication
(10) Pub. No.: US 2005/0286428 A1
(43) Pub. Date: Dec. 29, 2005

(54) Timeline management of network communicated information

(75) Inventors: Olli Oksanen, Helsinki (FI); Minna Mustakallio, Espoo (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/878,695

(22) Filed: Jun. 28, 2004

(51) Int. Cl. H04L 12/26

(52) U.S. Cl. 370/241

(57) ABSTRACT

A digital communication management application implemented in an electronic device, such as a digital communication device that provides for a topographic presentation or view of the quantity of digital communications associated with specific time periods. In addition, the communication view provides the capability to distinguish between different digital communications based on a chosen digital communication characteristic. The application further provides for readily available and accessible information pertaining to related communications and provides for a user to identify relational characteristics. As such, the communication view of the digital communication management application provides the user of the diary an efficient means of locating digital communications and assessing quantity of digital communications in relation to time span.

### FIELD OF THE INVENTION

The present invention relates to the management of network communicated information and, more specifically, to an application that provides for the visual display of a timeline that represents network communicated information and provides for the visual display of relational data pertaining to the communications.

### BACKGROUND OF THE INVENTION

The rapid growth of digital communication has made it possible for all kinds of digital information to be communicated amongst various types of wireless and wire line communication devices. For instance, the cellular or mobile telephone is no longer limited to telephonic voice communication and may include other means of digital communication, such as digital networking (i.e., Internet communication, electronic mail, text messaging, and the like). In addition, an increasing number of cellular telephones and other mobile wireless communication devices, such as portable computers, personal data assistants (PDAs) and the like, are being integrated with other means of capturing or producing digital media, such as digital cameras, digital audio recorders, digital video recorders and the like. Technological advances have made it possible for other digital devices, such as digital cameras, digital video recorders, digital audio devices and the like to be equipped with means for digital communication. As more and more digital devices possess the capability to digitally communicate with one another, the amount of digital information that will be communicated amongst these devices will increase at an alarming rate.

In addition to the onset of more and more digital devices possessing digital communication capabilities, the digital storage capacity of these devices is constantly increasing. In the near future the majority of mobile digital communication terminals may well be equipped with storage capacity in the gigabyte range or greater, allowing these devices to store an enormous amount of digital data. In this environment it will no longer be prohibitive from a memory capacity standpoint to store a voluminous amount communication files; i.e., email, voice messages, Short Message Service (SMS) messages, Multimedia Message Service (MMS) messages and the like. Additionally, larger memory capacity will provide for the storage of large file types, such as video, audio or other multidigital communications.

Over time, digital devices with large memory capacity possess the capability to acquire and store an enormous volume of digital communications. This is especially true as we enter a burgeoning digital communication era where more and more digital devices will possess the capability to communicate digitally. For example, in a future where more and multi-function digital devices have the capability to communicate digitally, the devices will be inundated with digital communications. The user of these devices, and all other digital devices capable of media storage, will desire an application that stores and manages the digital communications. A key attribute for such an application is user efficiency; because the user must be able to efficiently locate the digital communication. This task becomes more complicated as the digital device acquires more and more information in the form of digital communications.

An additional concern of handheld digital communication devices is that the display of such devices is typically minimal in size and applications that are implemented on the display must be able to be condensed and presented in a format that provides the user with accessibility to the functions of the application. It is typically easier and more efficient for the user of a handheld touch-screen display to search via a touch function, such as scrolling or the like, as opposed to searching via keystroke entry of text. Therefore, any application that manages digital communications on a handheld digital communication device must accommodate the typically small display of such devices and provide for an efficient means of locating the digital files with the management application.

In the digital communication environment where more and more digital devices, both wireless and wired, are equipped with a means for digital communication and where the storage capacity of these devices has become seemingly endless, the digital communication device will encounter and store innumerable digital communications. As such, the digital communication device will desire a means to access, store, manage and further communicate these digital communications in an efficient and user-friendly environment.

For example, if a digital communication device receives a digital communication, such as an email, a voice mail, an SMS/MMS message or the like, the user of the device would benefit greatly from an application that automatically places the file into a readily accessible storage area and where managing and accessing of the file in the future can occur efficiently, without the user having to spend a great deal of time searching for the digital communication. Additionally, the user of the device would benefit greatly from an application that provides ready access to a visual history of the communication in terms of related communications, editing history, or other relational parameters.

Therefore, the need exists to develop a digital communication management application that will provide for the visual presentation of communications, such that a user of the application can efficiently identify and access digital communications. In addition, the desired application should be capable providing a visual presentation of the relational information pertaining to the digital communications, such as the communication history, topic or title of the communication, author of the communication, relationship to other communications and the like.

### BRIEF SUMMARY OF THE INVENTION

The present invention provides for a digital communication management application implemented in an electronic device, such as a digital communication device. The digital communication management application provides for a communication presentation or view of the quantity of digital communications associated with specific time periods. In addition, the communication view provides the capability to distinguish between different digital communications based on a chosen digital communication characteristic. For example, the application may distinguish between incoming and outgoing communications or the application may distinguish between communication type (e.g., email versus voice mail, etc.) In addition, other digital communication characteristics may be graphically distinguished in the communication view. The chosen characteristic may be dictated by the configuration of the application or the chosen characteristic may be defined by the user of the application. In the topographic presentation the quantity of digital communications are represented graphically, typically in a line graph or bar graph type presentation. The quantity of digital communications may be defined by the number of digital communications or the storage volume of digital communications.

Additionally, the present invention provides for a communication management application that readily identifies, represents and provides access to related communications. The application provides for the user to identify the relational characteristic, such as communication history, communication author/originator, communication title/topic or the like. Once the characteristic is identified, such as via metadata associated with the communications, the application assembles the related communication grouping and visually presents the same to the user, typically in a relation view in conjunction with the time-line and communication views. As such, the digital communication management application provides the user an efficient means of locating digital communications, assessing quantity of digital communications in relation to time span and identifying and accessing communications that are related to one another.

In a first embodiment of the invention an application for providing access to digital communications on a digital device is defined. The application includes a computer readable storage medium having computer-readable program instructions embodied in the medium. The computer-readable program instructions will include first instructions for generating a time-line view that segments time into time units and second instructions for generating a communication view that graphically represents digital communication quantity in relation to the time units presented in the time-line view. The time-line view will define periods of time and time units based on either configuration of the digital communication management application or user selection. The time periods and time units may be chosen from any period or unit, such as a year, month, week, date, hour, minute or the like. The period of time and time units will typically be optimized based on the quantity of digital communications that will be graphically displayed in the associated communication view.

The communication view will typically graphically distinguish between digital communications based on a chosen digital communication characteristic. For example, the communication view may distinguish between incoming and outgoing communications or the view may distinguish between the types of communications (i.e., email, voice mail, facsimiles, SMS, MMS, etc). The chosen digital communication characteristic may be determined by digital communication management configuration or the chosen digital communication characteristic may be specified by the user.

The second instructions of the application may further provide for representing a predetermined relationship between a selected digital communication and one or more related digital communications. The predetermined relationship will typically be determined by analyzing metadata information associated with the digital communications. Examples of predetermined relationships include, for example communication history, editing history, communication originator, communication author, communication title, communication topic and the like.

The application may additionally include third instructions for generating a preview view that displays at least a portion of a digital communication selected from the communication view. In addition, the preview view may include the display of the contents, or portions thereof, of previous and next in-time communications or related communications.

The communication view may further include a baseline representation for dividing the graphical representations into more than one portion of the communication view. Typically, the baseline representation will be a dividing line that divides the communication view into two portions, such as an upper portion and a lower portion. The baseline representation provides for the ability to divide the graphical representations provided in the communication view based on a chosen distinguishing digital communication characteristic. For example, digital communications of one type, such as audio communications, may be graphically represented on the upper portion of the view and digital communications of another type, such as text communications, may be graphically represented on the lower portion of the view.

The communication view may further include a zoom mechanism that provides for a detailed graphical representation of digital communications. The zoom mechanism will allow the user to view a more detailed topographic representation of digital communications. For example, in a standard communication view the digital communications may be represented by a line graph and in the zoomed-in detailed view the digital communications may be represented individually by icons in a bar graph format. Typically, the more detailed view will present a shorter time span and shorter time units within the time span. Additionally, the detailed view will provide for the digital communication representations to be more clearly delineated and in more detail than the standard view. The zoom mechanism may also provide for the digital communications to be accessed through detailed graphical representation of the digital communications.

The communication view may further include a focus mechanism that provides for the graphical representation of digital communications to be previewed and/or accessed by cursor movement in a vicinity of the graphical representation. By way of example, as a cursor is moved over a line graph representation of digital communications, the focus mechanism will display detail related to the digital communication associated with that portion of the line graph and will allow the user to access the digital communication via activation of the displayed detail.

The communication view may further include geometric identifiers, in the form of lenses, for identifying areas within the view that include digital communications that are responsive to a search conducted by the user. The digital communication management of the present invention will have a searchable database of metadata information related to each individual digital communication. A user may perform a keyword search or a filtering-type search to locate digital communications of interest. The communication view may display the results of such a search by presenting a lens over the area of the view in which the searched file or files reside. The lens may be altered in format to identify different search results or to signify the amount of searched files in the identifying area.

The communication view may further include a highlighting function that provides for the highlighting of time periods within the communication view to identify areas of user interest. For example, if the user of the application wishes to identify a time span related to a specific event in the user's life, the user may highlight the time span to accentuate the area and make it easier for the user to locate the time span when browsing in the communication view mode.

A further embodiment of the invention is defined by a digital device having a processing unit that executes computer-readable program instructions for accessing digital communications. The computer-readable program instructions include first instructions for generating a time-line view that segments time into time units and second instructions for generating a communication view that graphically represents digital communication quantity in relation to the time units presented in the time-line view. Additionally, the digital device will include a display in communication with the processing unit that presents the user access to digital communications through the time line and communication views.

The invention is further defined by a method for providing a communication view in a digital communication management application. The method includes the step of defining a time span and time units within the time span, determining the quantity of digital communications in the digital communication management application that are associated with the defined time units and providing a communication view that graphically represents the quantity of digital communications in the digital communication management application that are associated with the time units. The method may additionally include the step of defining a digital communication characteristic, determining the quantity of digital communications that include the digital communication characteristic, determining the quantity of digital communications having the characteristic that are associated with the defined time units and providing a communication view in conjunction with the time bar display. The communication view graphically represents the quantity of digital communications, by digital communication characteristic that are associated with the time units in the time bar.

As such, the digital communication management application of the present invention provides for a topographic presentation or view of the quantity of digital communications associated with specific time periods. In addition, the communication view provides the capability to distinguish between different digital communications based on chosen digital communication characteristic. In the topographic presentation the quantity of digital communications are represented graphically, typically in a line graph or bar graph type presentation. The application further provides for readily available and accessible information pertaining to related communications and providers for a user to identify relational characteristics. As such, the communication view of the digital communication management application provides the user of the diary an efficient means of locating digital communications and assessing quantity of digital communications in relation to time span.

### BRIEF DESCRIPTION OF THE DRAWINGS

Having thus described the invention in general terms, reference will now be made to the accompanying drawings, which are not necessarily drawn to scale, and wherein:

FIG. 1 is an illustration of a view of the communication management application that implements a timeline, preview and communication view, in accordance with an embodiment of the present invention.

FIG. 2 is an illustration of a view of the communication management application that implements a timeline, communication and relational view, in accordance with an embodiment of the present invention.

FIG. 3 is an illustration of a view of the communication management application that implements a timeline, preview, relational and communication view, in accordance with an embodiment of the present invention.

FIG. 4 is an illustration of a view of the communication management application that implements a timeline, preview, relational view and communication view, in accordance with an embodiment of the present invention.

FIG. 5 is an illustration of a view of the communication management application that implements a calendar month time-line, in accordance with an embodiment of the present invention.

FIG. 6 is an illustration of a view in a digital communication management application incorporating a zoom mechanism, in accordance with an embodiment of the present invention.

FIG. 7 is an illustration of a view in a digital communication management application incorporating lenses for identifying areas where search results reside, in accordance with an embodiment of the present invention.

FIG. 8 is a block diagram of a digital device implementing a digital communication management application, in accordance with an embodiment of the present invention.

FIG. 9 is a flow diagram of a method for representing digital communications in a communication view of a digital communication management application, in accordance with an embodiment of the present invention.

FIG. 10 is a flow diagram of a method for providing a relational view of related digital communications in a digital device, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides for a communication management application implemented in an electronic device, such as a digital communication device. The communication management application provides the capability to manage all of the various communication types that are received by a digital communication device. By way of example, these communication types may include electronic mail (i.e., email), Short Message Service (SMS), Multimedia Message Service (MMS), facsimile, recorded telephone calls, voice messages and the like. In addition, these communication types may embody image files, audio files, video files, text files, and the like. The communication management application of the present invention provides an efficient and effective means for locating and accessing communications, as well as, analyzing relationships between related communications.

The digital communication management application provides for a communication presentation or view of the quantity of digital communications associated with specific time periods. In addition, the communication view provides the capability to distinguish between different digital communications based on a chosen communication characteristic. In certain embodiments, the chosen characteristic will be communication type, such as email, SMS, MMS, fax, voice message or the like or the chosen characteristic may be communication file type, such as image file, video file, audio file, text file, and the like. In addition, other communication characteristics may be graphically distinguished in the communication view. These other communication characteristics may include communications related to a specific individual, communications related to a specific group, communications related to a specific topic or communications related to a specific location.

In the communication presentation the quantity and/or density of digital communications are represented graphically, typically in a line graph, envelope curve, stacked area or bar graph type presentation. The number or quantity of digital communications may be defined by the number of communications or the storage volume occupied by the communications. As such, the communication view of the digital communication management application provides the user of the application an efficient means of locating digital communications and assessing quantity of digital communications in relation to time span.

The communication view will be adaptable, such that, the user may configure the communication view as the application dictates. For example, the user will be able to define the time span, such as a year, month, week, etc., that the communication view will encompass. Additionally, the user will be able to define the type of digital communications that will be presented in the communication view and the manner in which the digital communications are presented in the communication view.

Additionally, the communication view will provide the user with tools to efficiently assess and/or access files within the management application. In certain embodiments the management application will indicate, for selected digital communications, related or associated communications. The application may predefine the relationship characteristic or the user may define the relationship characteristic. Relationship characteristics include but are not limited to, communication history, edit history, communication author, communication sender, communication topic, communication title and the like.

In other embodiments of the invention, the graphical representation of digital communications will provide focus and zoom functions for the purpose of isolating a digital communication within a graph or providing access to a view of a portion of a time span, e.g., zooming from a year time span to a month time span or zooming from a month time span to a week time span. The focus function may allow for a cursor to be positioned over a segment or an area of the communication view to display more detailed representations of the digital communications associated with that portion of the communication view. Once a user has zoomed-in or focused-in to a desired digital communication, the user may be able to access the digital communication by mouse-type activation or predefined keystroke.

The communication view may also provide the user the ability to isolate regions within the time span of the view, in which, desired digital communications exist. In this regard, the application will provide for digital communications to be searched based on the unique metadata information that is connected to each digital communication. These searches may be in the form of keyword searches from the metadata database or filtering the digital communication database by a file characteristic, such as communication type, file size or the like. In the communication view the results of these searches may be presented as geometric icons displayed over an area of the communication view, herein referred to as a lens or any other means of graphically illustrating the search results within the communication view may be implemented. The size and shape of the lens or any other geometric identifier that illustrates the search results may vary.

The digital communication management application of the present invention may be implemented and executed on any electronic device that incorporates a display, such as a desktop or portable computer, cellular telephone, personal data assistant (PDA), digital camera, digital camcorder, e-book device, television, digital audio player or the like. In addition the digital communication management application may be implemented on electronic devices that are connected to an external display, such as a set-top box (STB), personal video recorder (PVR), digital video recorder (DVR) or the like. While in most implementations the digital device that executes the digital communication management application will be capable of any type of wireless or wireline network communication, such as wireless telecom, short range radio network, Bluetooth®, Wireless Local Area Network (WLAN), Radio Frequency Identification (RFID), Internet Protocol Data Casting (IPDC), Digital Video Broadcasting (DVB), Infrared Data Association (IrDa), Internet or the like, it is not required that the digital device be adapted to communicate via network. Devices that are capable of acquiring digital communications internally or accessing digital communications through memory devices (e.g., flash storage device, memory sticks, video and audio storage tapes, CD, DVD, removable hard disc device (HDD) and the like) are also applicable.

In accordance with an embodiment of the present invention, the digital communication management application will be embodied by a computer-readable storage medium having computer-readable program instructions stored in the medium. The storage medium will typically be a memory device, such as flash ROM memory, HDD or the like. The programming instructions may be written in a standard computer programming language, such as C++, Java or the like. Upon execution by a processing unit as described below, the program instructions will implement the various functions of the digital communication management application as described below. The computer-readable program instructions include first instructions that will generate a time-line view that segments time into time units. The computer-readable program instructions also includes second instructions that will generate a communication view that graphically represents digital communication quantity in relation to the time units presented in the time-line view. The communication view may also graphically distinguish between digital communications of a chosen characteristic, such as digital communication type, topic, author, sender or the like. While the first and second instructions may be modules, objects or the like that communicate with one another, the instructions need not be discrete or separable portions of the program instructions and may be interspersed throughout if so desired.

The digital communications that are managed by the application of the present invention will typically have associated metadata, in the form of a timestamp, communication title, file name, location information, communication author, communication sender, objects in the digital communication, file type, file size or the like. The communication metadata will serve as the basis for associating the communication with an appropriate time, typically the time at which the communication was sent or received. In addition, and as explained in further detail below, communication metadata may also be relied upon to parse the overall collection of communications into a predetermined category of communications, search for communications of interest and to identify related communications.

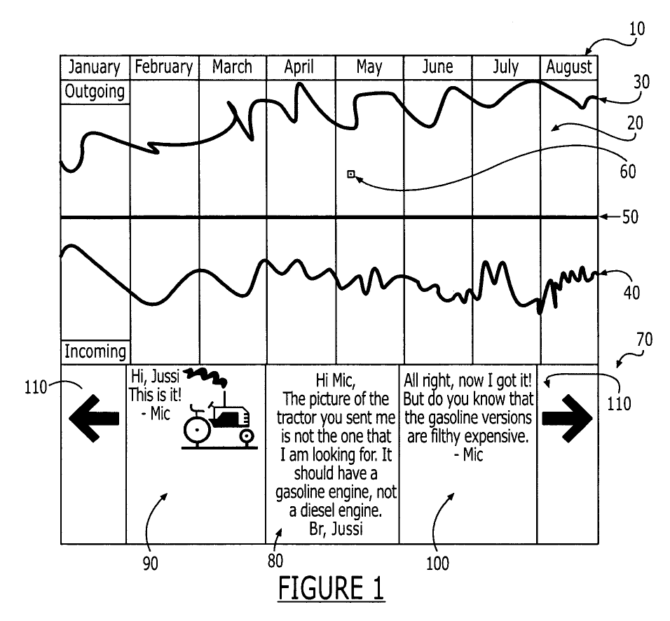

FIG. 1 provides an illustration of an exemplary time-line view in combination with a communication view and a communication view in accordance with an embodiment of the present invention. The time-line view 10 provides for segmenting time into time units, herein depicted; the time units define months, specifically the months of January through August are visible in the view. The user of the digital communication management application may be provided the capability to configure the time-line view with the desired units of time. For example, if the user desires to observe information related to the quantity of digital communications over a long time span, the time-line view may define units of time as years, decades or centuries, etc. If, however, the user desires to observe information related to the quantity of the digital communications over a short time span, the time-line view may define units of time as weeks, days, hours or minutes, etc. The width of the time units in the time-line view may be consistently fixed or it may vary from one unit of time to another.

The communication view 20 overlies the time-line view and graphically represents digital communication quantity in relation to the time units presented in the time-line view. In the illustrated embodiment, the digital communications have been sub-divided and presented according to whether the communication was an outbound communication or an inbound communication. The upper line graph 30 of the communication view represents the quantity of outgoing or sent communications and the lower line graph 40 represents the quantity of incoming or received communications. A centerline 50 divides the upper portion of the graph from the lower portion. In alternate embodiments, the communication view may omit the centerline, in such embodiments the presentation is a stacked area view. In alternate embodiments, the digital communications may be subdivided and presented according to other predefined criteria. Predefined criteria may include, but is not limited to, the type of communication, the file type, the communication author, the communication sender, the communication topic and the like.

In the illustrated embodiment, the user has selected a first communication 60. Selection of the communication may occur by input of a search query to a related search engine (not shown in FIG. 1) or by mouse-like cursor activation of an area underlying one of the line graphs. In the illustrated embodiment, only the selected first communication is represented within the communication view, however, in alternate embodiments icons, thumbnails, windows or the like may represent all of the communications that have been sent and/or received. As dictated by display size constraints, the icons, thumbnails, windows or the like may depict a portion or the entirety of the contents of the communication. Additionally, color-coding or some other form of highlighting of the icons, thumbnails, windows, etc., may be used to distinguish the communication type or other feature of the communication. For example, a red icon or thumbnail border may indicate an email, while a blue icon or thumbnail border indicates a voice mail communication.

The FIG. 1 illustration also provides a depiction of an optional preview view that is displayed in conjunction with the time-line and communication views. The preview view 70 will typically provide for a primary message window 80 that displays a portion or the entirety of the selected first communication 60. In addition, the preview view may provide for the display of the secondary message windows 90 and 100. For example, the secondary message windows may display a portion or the entirety of the previous or next in-time communications or some other communication that is otherwise related to the communication displayed in the primary message window. Additionally, the preview view may provide for arrow keys 110 that, upon keystroke or mouse cursor activation, provide for the scrolling of message windows. Typically, the scrolling will be in relation to time although scrolling in relation to other parameters, such as type, topic, author or the like, is also possible.

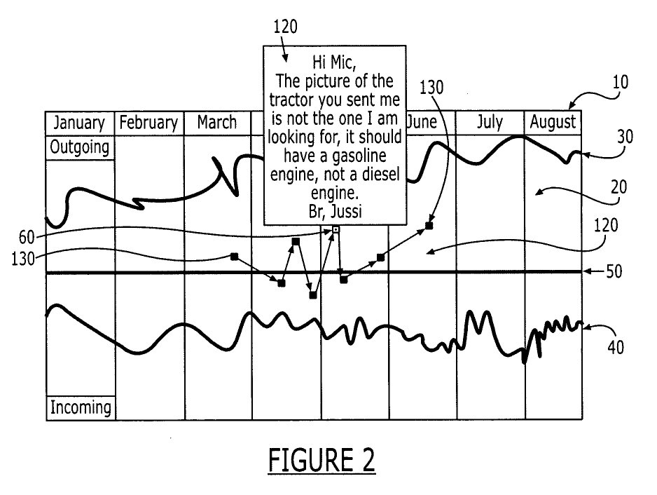

In addition to providing for an optional preview view 70, the contents of the selected communication 60 may be displayed in a pop-up type window or panel that is typically represented over the timeline view 10 and communication view 20. FIG. 2 provides an illustration of a timeline view in conjunction with a communication view, in accordance with an embodiment of the present invention. In the FIG. 2 embodiment the selected first communication 60 is associated with the message panel 120. The message panel will display a portion of or the entirety of the contents of the selected first communication. Typically, the message panel will be invoked by providing a keystroke or a mouse activation function to the designator that identifies the selected communication.

In addition to providing an optional means for displaying the contents of the communication, FIG. 2 also illustrates the novel concept of presenting a relational view 120 in conjunction with the timeline view 10 and the communication view 20. Metadata information associated with the communications allows the communication management application to group communications according to predefined relational characteristics. The relational view depicts one or more communications 130 that are related to the selected first communication 60 by a predefined relational characteristic. For example, in the illustrated embodiment the first communication may be email and the related communications may be other email communications in the same email chain that preceded or followed in time the first communication. Such an example is illustrative of the communication history being the predefined relational characteristic. Other predefined relational characteristics include, but are not limited to, editing history of the communication, authorship of communications, sender of communications, topic or title of communications and any other relationship between communications. The predefined relational characteristic may be configured by the communication management application or, more typically, the user of the application may define the relational characteristic that best suits their particular need.

In the illustrated embodiment of FIG. 2 the relational view 120 is indicated by connector lines 140 the selected first communication 60 and the one or more related communications 130. In alternate embodiments the relation may be represented by other visual means, such as highlighting the related communications, color-coding the related communications and the like.

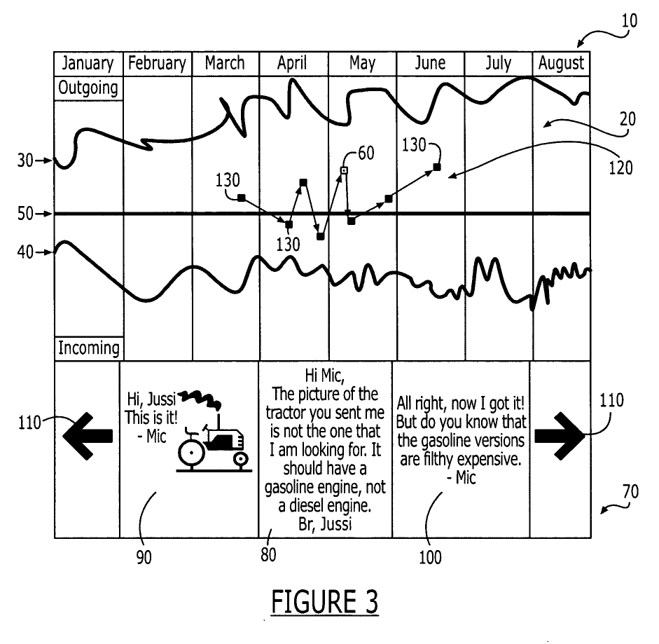

FIG. 3 illustrates a combined view of the communication management application that implements time-line, preview, relational and communication views, in accordance with an embodiment of the present invention. In the FIG. 3 embodiment the contents of the selected first communication 60 is displayed in the primary message window 80 and next and previous in-time related message content is displayed in the secondary message windows 90 and 100. A user of the application may select the next related message in the chain or any other related message by arrow key 110 activation or by mouse cursor activation. Selection of the next message or any other related message will result in the contents of the newly selected message being displayed in the primary message box.

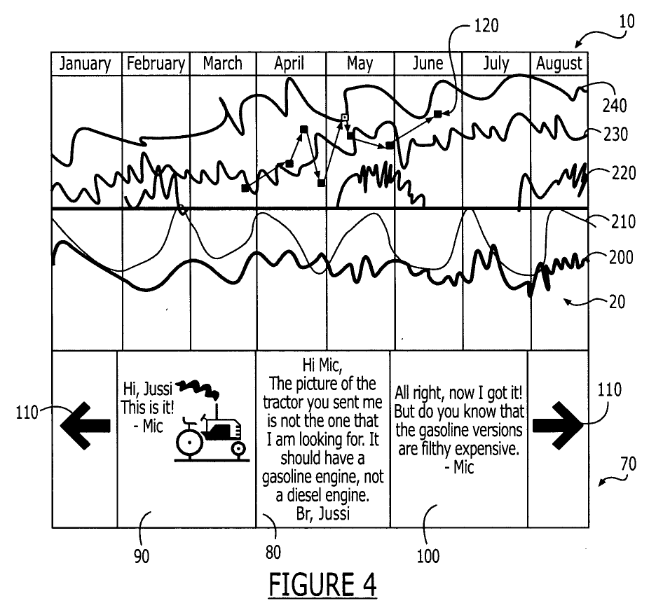

FIG. 4 is illustrative of a view of the communication management application in which the communication view of communications is segregated according to communication type, in accordance with an embodiment of the present invention. Each of the unique line graphs is associated with a specific digital communication characteristic, such as digital communication type, digital communication size or any other distinguishing file characteristic that is stored in the associated metadata file. The user of the digital communication management will be able to configure the communication view, such that only digital communications of interest to the user are displayed in the view. As such, the user can dictate the amount of line graphs that are displayed in the view, as well as, the digital communication characteristic that is being analyzed by the view. For example, the first line graph 200 may graphically represent the quantity of voice message communications, the second line graph 210 may graphically represent the quantity of recorded telephone communications, the third line graph 220 may graphically represent the quantity of SMS/MMS communications, the fourth line graph 230 may represent the quantity of facsimile communications and the fifth line graph 240 may represent the quantity of email communications. It is noted that the FIG. 4 embodiment, for the sake of clarity, does not differentiate between outgoing and incoming communications. In a typical view, the area underlying each line graph will be color-coded, shaded or otherwise marked to indicate the quantity of communications corresponding to the characteristic of interest.

The view of FIG. 4 is also provided with an optional baseline or centerline 50 that provides a frame of reference to divide the communication view into two portions. In this regard the baseline may delineate between certain file types. For instance, in the example above the baseline, lines 220-240, are associated with visual communications, while the lines below the baseline, lines 200-210, are associated with audio files. In addition to delineating between file types, the baseline serves to insure the line graphs that are presented in the view are easily distinguishable from one another. Being able to easily distinguish between line graphs is essential to the subsequently described zoom and focus functions.

While the communication views of FIGS. 1-4 implement line graphs to illustrate the quantity of digital communications associated with a time period, it is also possible for the communication view to illustrate the quantity of digital communications in other graphical formats. For instance, bar graphs may be provided, in which the bar graph includes preview images, thumbnail images or other graphical indicators of the content of the digital communication. It is also possible to implement envelope curves, stacked area presentations or any other graphical depictions to indicate the quantity of digital communications associated with a period of time.

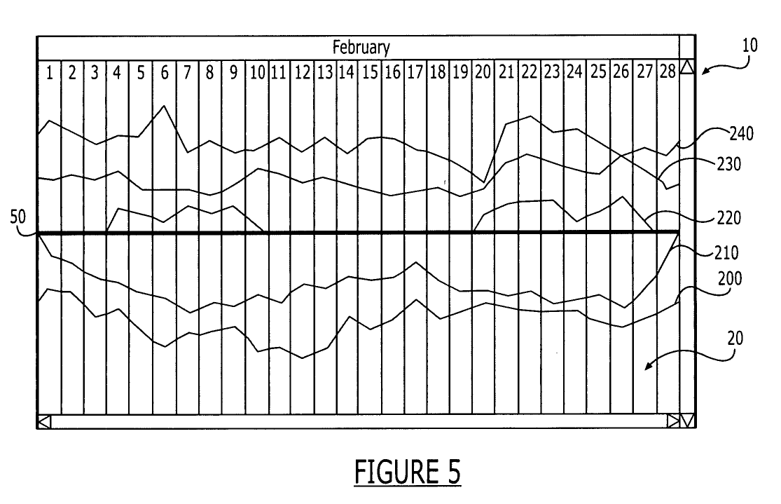

FIG. 5 illustrates an alternate example of the time-line view 10, in which the time span of the view is depicted in terms of days, in accordance with an alternate embodiment of the present invention. The time-line view of FIG. 5 identifies units of time, as days, herein depicted; the days in the month of February are visible in the view. As previously discussed, the user of the digital communication management application is typically provided the capability to configure the timeline view with the desired units of time visible. The communication view of FIG. 5 incorporates line graphs 200-240 that indicate the quantity of digital communications for a specific digital communication characteristic, such as digital communication type, in relation to the time period. The depicted view also illustrates an optional baseline 50 that provides a frame of reference to divide the communication view into two portions.

The FIG. 1-5 embodiments may provide for a zoom mechanism, typically implemented by having a mouse cursor moved across the communication view, such that when the cursor encounters a graph, the digital communications that are associated with the area underlying the graph are displayed, typically via a separate pop-up window or panel. From the pop-up window display of digital communications, the user may be provided with access to a specific digital communication by activating the icon that represents the digital communication; typically activation will involve a mouse-type input or a keystroke on an associated keypad.

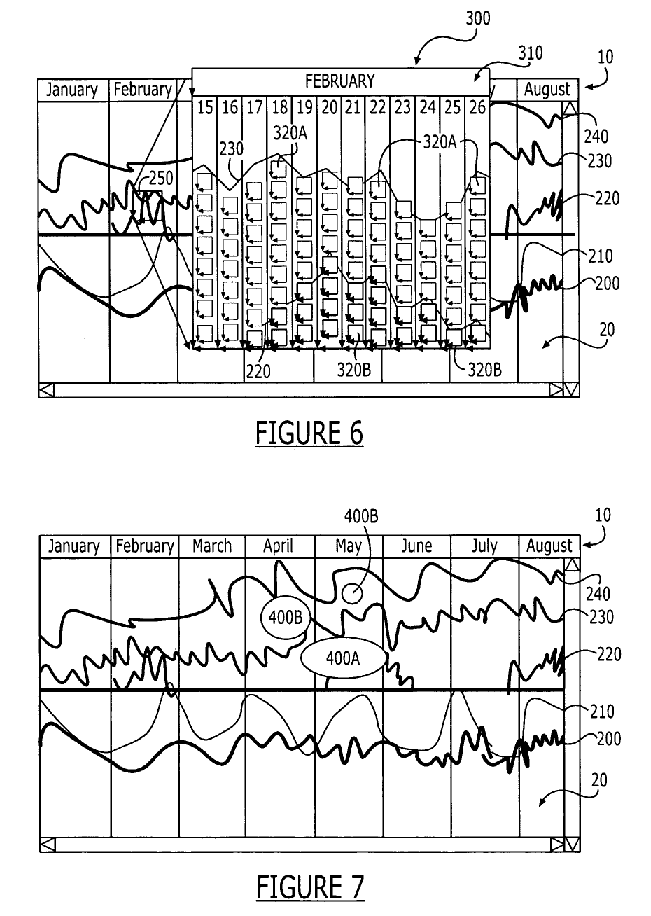

FIG. 6 illustrates a communication management application view, in which a user has zoomed-in on a specific portion of the view to display a more detailed communication view of a specific time period and digital communication type, in accordance with an embodiment of the present invention. The FIG. 6 embodiment illustrates the same general communication view that is displayed in FIGS. 4 and 5. The time-line view 10 defines units of time as months, herein depicted, the time spans from the month of February to the month of August. The communication view 20 of FIG. 6 additionally incorporates line graphs 200-240 that indicate the quantity of digital communications for a specific digital communication characteristic, such as digital communication type, in relation to the time period. The depicted view also illustrates an optional baseline 50 that provides a frame of reference to divide the communication view into two portions.

In the FIG. 6 embodiment the user of the communication view has activated a zoom function to pull-up a more detailed view 300 of an area of interest 250. As depicted the area of interest includes line graphs 220 and 230 for a time span in the month of February. The zoom function for the area of interest may be implemented by passing a cursor over the chosen area and activating the area of interest, typically by a mouse-type input or a keystroke. Activating the area of interest will cause the detailed view 300 to appear in a separate window display.

In the detailed view 300 the time-line view 310 defines a time span in terms of units of days, in this instance a twelve-day time span between 15 February and 26 February. The detailed view displays the digital communications associated with the area of interest 250. In the detailed view the digital communications are represented by icons 320. The icons may include a preview of the content of the digital communication, such as a thumbnail image of a portion of the digital communication, or the icon may include any other characteristic representation of the digital communication. As such, in this instance, the detailed communication view provides for the exact number of digital communications in the area of interest and an icon for each of the digital communications. In the depicted embodiment the standard faced icons 320A represent the same digital communication type that is represented by line graph 230 and the bold faced icons 320B represent the same digital communication type that is represented by line graph 220. It is also noted that the line graphs 220 and 230 are illustrated in the detailed view in blown-up, zoomed-in detail.

The icons 320 of the detailed view 300 will provide the user of the digital communication management application access to the full content of the digital communication. Typically, the user will activate the digital communication by mouse-type input or keystroke to display or otherwise access the digital communication in its entirety.

FIG. 7 provides an illustration of a communication view incorporating geometric identifiers 400, referred to herein as lens, that designate areas within the view that include digital communications that include the results of a search, in accordance with an embodiment of the present invention. As previously noted, the digital communications will have metadata information associated with the file. The information is typically created automatically or manually at time the digital communication is created. The metadata information that is associated with the digital communications is searchable data that a user may search via conventional key word searching techniques, Boolean operators, filtering of metadata information characteristics or through visual scrolling means.

In the depicted embodiment of FIG. 7 lenses 400 are illustrated that are geometric identifiers of areas in which searched digital communications can be located. Thus, a lens will appear when a user conducts a metadata search for a specific file or specific file types. The lens will typically remain active, to illustrate the search results, until the user designates the lens for removal. Different lens types may indicate results of different searches. For example, in the illustrated embodiment the oval dark-shaded lens 400A indicates results of a first search and the circular light-shaded lenses 500B indicate results of a second search. The size of the lens will typically indicate the amount of digital communications in the lens area that meet the search criteria. In addition the shading of the lenses or the geometric shape of the lenses may indicate the quantity of digital communications within the lens area that meet the search criteria.

In addition to the use of lens, the communication view may include color-coding or shading of specific regions within the communication view for the purpose of highlighting specific time periods of interest, typically time periods that a user will frequently visit to access associated digital communications. Color-coding and shading of time periods of interest may be defined by the user based on user preferences. For example, a user may desire to highlight a time period that corresponds to the birth period of a child. In this regard, the user may highlight the area as blue or pink for the purpose of easily identifying this area when trying to locate specific digital communications.

In addition, the highlighted area may be permanent and recalled to the communication view by a user whenever desired. Metadata information related to the highlighted areas is stored in the system and may be displayed and listed in a bookmark or annotation list.

A further embodiment of the invention is defined by a digital device that implements the digital communication management, in accordance with an embodiment of the present invention.

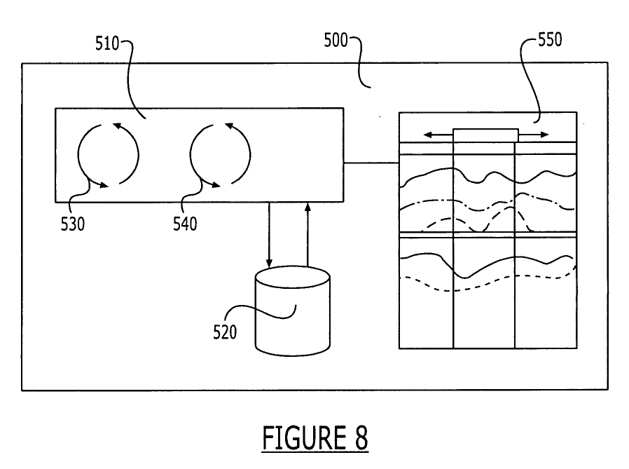

FIG. 8 illustrates a block diagram of a digital device 500 that implements the digital communication management and communication view presentation. As previously noted, the digital device will typically be a digital device capable of digital communication with other digital devices, such as a mobile terminal including for example, a mobile telephone, a PDA, laptop computer or the like. However, the digital device may be any other device capable of displaying the digital communication management of the present invention such as a digital camera, digital video recorder, digital audio recorder or the like.

The digital device 500 will include a processing unit 510, such as a processor, an application specific integrated circuit, analog and/or digital circuitry, or any other similar device that executes computer-readable program instructions for accessing digital communications. Wherein the program instructions and the digital communications are generally stored in memory device 520. The computer-readable program instructions will include first instructions 530 for generating a time-line view that segments time into time units, and second instructions 540 for generating a communication view that graphically represents digital communication quantity in relation to the time units presented in the time-line view. The second instructions may also provide for generating a communication view that distinguishes digital communications based on a chosen digital communication characteristic. In addition, the digital device will include, or may be in external communication with, a display 550 that is in communication with the processing unit and provides a presentation mechanism for the time-line view in conjunction with the communication view.

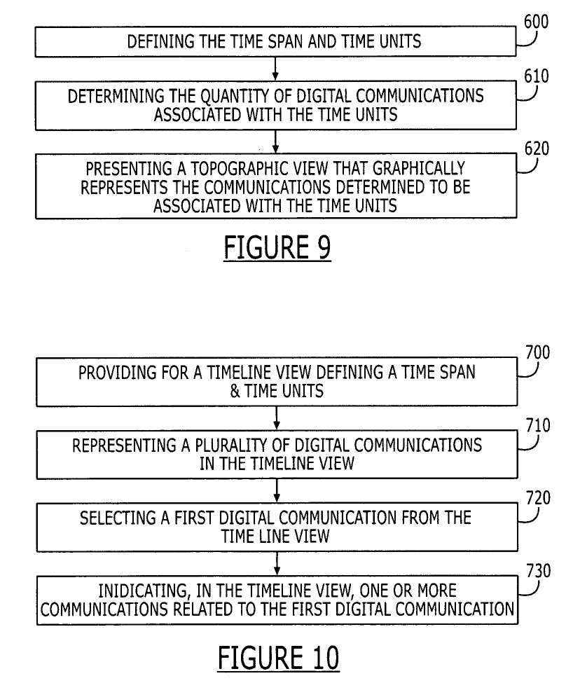

The present invention is also embodied in a method for representing media items in a communication view within a digital communication management application. FIG. 9 provides a flow diagram of such a method, in accordance with an embodiment of the present invention. At step 600, a time span and time units within the time span are defined. These may be defined by digital communication management configuration or by digital communication management user selection. At step 610, a determination is made by the digital communication management application as to the quantity of digital communications in the diary that are associated with the defined time units. This step is accomplished by analyzing the metadata information associated with the communications, typically the communication timestamp. At step 620, a communication view is presented that graphically represents the quantity of digital communications in the digital communication management application that are associated with the time units in the time bar.

In alternate embodiments the method may include the steps of defining a digital communication characteristic, determining the quantity of digital communications that include the digital communication characteristic, determining the quantity of digital communications having the characteristic that are associated with the defined time units and graphically representing in the communication view quantity of digital communications, by digital communication characteristic, that are associated with the time units in the time bar. In this regard, the digital communications are not only presented in terms of their quantity associated by a time unit but are further distinguished based on digital communication characteristic, such as digital communication type or the like.

A further method is defined for providing a relational view of related digital communications in a digital device. FIG. 10 provides a flow diagram of such a method, in accordance with an embodiment of the present invention. At step 700, a timeline view is provided that defines a time span and time units within the time span. The time span and the time units may be defined by digital communication management configuration or by digital communication management user selection. At step 710, a plurality of digital communications are represented in the timeline view. Typically, the digital communications will be represented in a graphical format, such as a line graph, a bar graph, an envelope curve or the like. In graphical format the representations will indicate the quantity of communications for any given time unit. As such, the method will typically involve analyzing metadata information associated with the plurality of digital communications to determine a time associated with the communication. The graphical representations may further indicate a chosen characteristic of interest, such as communication type, communication topic/tile, communication originator or the like.

At step 720, a user will select a first digital communication from the timeline view. The first digital communication will serve as the root communication for all related communications. Typically, the first digital communication is determined by searching, scrolling or some other form of communication identification. Additionally the first communication may be selected by mouse-like cursor activation of a representation in the time-line view. At step 730, the method provides for the indication, within the timeline view, of one or more digital communications that are related to the first digital communication by a predetermined relational characteristic. Relational characteristics may include, but are not limited to, communication history, edit history, communication author, communication sender, communication title and communication topic. Indication may involve highlighting or color-coding the related communications, connecting the related documents by connection lines or any other form of visible or audible identification of the related communications.

The described embodiments of the present invention provide for a digital communication management application that provides for a topographic presentation or view of the quantity of digital communications associated with specific time periods. In addition, the communication view provides the capability to distinguish between different digital communications based on a chosen digital communication characteristic. In the topographic presentation the quantity of digital communications are represented graphically, typically in a line graph or bar graph type presentation. Additionally, the application provides for readily available and accessible information pertaining to related communications and provides for a user to identify relational characteristics. As such, the communication view of the digital communication management application provides the user an efficient means of locating digital communications and assessing quantity of digital communications in relation to time span.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An application for providing access to digital communications, the application comprising a computer readable storage medium having computer-readable program instructions embodied in the medium, the computer-readable program instructions comprising:
first instructions for generating a time-line view that segments time into time units; and
second instructions for generating a communication view that graphically represents digital communication quantity in relation to the time units presented in the time-line view.

2. The application of claim 1, wherein the second instructions for generating a communication view that graphically represents digital communication quantity in relation to the time units presented in the time-line view further provides for a graphical representation of incoming digital communication quantity in relation to the time units presented in the time-line view.

3. The application of claim 1, wherein the second instructions for generating a communication view that graphically represents digital communication quantity in relation to the time units presented in the time-line view further provides for a graphical representation of outgoing digital communication quantity in relation to the time units presented in the time-line view.

4. The application of claim 2, wherein the second instructions for generating a communication view that graphically represents digital communication quantity in relation to the time units presented in the time-line view further provides for a graphical representation of outgoing digital communication quantity in relation to the time units presented in the time-line view.

5. The application of claim 1, wherein the second instructions for generating a communication view that graphically represents digital communication quantity in relation to the time units presented in the time-line view further defines digital communication quantity as the number of digital communications.

6. The application of claim 1, wherein the second instructions for generating a communication view that graphically represents digital communication quantity in relation to the time units presented in the time-line view further defines digital communications quantity as the storage volume of digital communications.

7. The application of claim 1, wherein the second instructions for generating a communication view that graphically represents digital communication quantity in relation to the time units presented in the time-line view further provides for graphically distinguishing between digital communications of a chosen communication characteristic.

8. The application of claim 7, wherein the second instructions for generating a communication view that graphically distinguishes between digital communications of a chosen communication characteristic further defines the chosen communication characteristic as communication type.

9. The application of claim 1, wherein the second instructions for generating a communication view that graphically represents digital communication quantity in relation to the time units presented in the time-line view further provides for representing a predetermined relationship between a selected digital communication and one or more related digital communications.

10. The application of claim 9, wherein the second instructions determines the predetermined relationship by analyzing metadata information associated with the digital communications.

11. The application of claim 9, wherein the predetermined relationship is chosen from the group consisting of communication history, editing history, communication originator, communication author, communication title, and communication topic.

12. The application of claim 1, wherein the second instructions for generating a communication view that graphically distinguishes between digital communications of a chosen communication characteristic further includes instructions for generating a zoom mechanism that provides for a detailed graphical representation of digital communications.

13. The application of claim 12, wherein the second instructions for generating a zoom mechanism further provides for the zoom mechanism that provides for a detailed graphical representation of digital communications and the ability to access the digital communications via the detailed graphical representation.

14. The application of claim 1, wherein the second instructions for generating a communication view further includes instructions for generating a focus mechanism that provides for the digital communications to be previewed.

15. The application of claim 1, wherein the second instructions for generating a communication view further includes instructions for generating lenses for identifying areas within the communication view that include results of a search of the digital communications.

16. The application of claim 1, wherein the computer-readable program instructions further comprise third instructions for generating a preview view that displays at least a portion of a digital communication selected from the communication view.

17. The application of claim 16, wherein the third instructions for generating a preview view that displays at least a portion of a digital communication selected from the communication view further displays at least a portion of a next-in-time digital communication.

18. The application of claim 16, wherein the third instructions for generating a preview view that displays at least a portion of a digital communication selected from the communication view further displays at least a portion of a previous-in-time digital communication.

19. An application for providing access to digital communications, the application comprising a computer readable storage medium having computer-readable program instructions embodied in the medium, the computer-readable program instructions comprising:
first instructions for generating a time-line view that segments time into time units; and
second instructions for generating a relational view that represents a predetermined relationship between a selected digital communication and one or more related digital communications in relation to the time units presented in the time-line view.

20. The application of claim 19, wherein the second instructions for generating a relational view represents the predetermined relationship by highlighting the selected digital communication and the one or more related digital communications.

21. The application of claim 19, wherein the second instructions for generating a relational view further represents the predetermined relationship by providing for one or more connector lines between the selected digital communication and the one or more related digital communications.

22. The application of claim 19, wherein the second instructions for generating a relational view that represents a predetermined relationship further defines the predetermined relationship as communication history between the selected digital communication and one or more related digital communications.

23. The application of claim 19, wherein the second instructions for generating a relational view that represents a predetermined relationship further defines the predetermined relationship as editing history between the selected digital communication and one or more related digital communications.

24. The application of claim 19, wherein the second instructions for generating a relational view that represents a predetermined relationship further defines the predetermined relationship as a relation between a communication author of the selected digital communication and a communication author of the one or more related digital communications.

25. The application of claim 19, wherein the second instructions for generating a relational view that represents a predetermined relationship further defines the predetermined relationship as a relation between a communication sender of the selected digital communication and a communication sender of the one or more related digital communications.

26. The application of claim 19, wherein the second instructions for generating a relational view that represents a predetermined relationship further defines the predetermined relationship as a relation between a communication title of the selected digital communication and a communication title of the one or more related digital communications.

27. The application of claim 19, wherein the second instructions for generating a relational view that represents a predetermined relationship further defines the predetermined relationship as a relation between a communication topic of the selected digital communication and a communication topic of the one or more related digital communications.

28. A digital device, the device comprising:
a processing unit capable of generating a time-line view that segments time into time units, and further capable of generating a communication view that graphically represents digital communication quantity in relation to the time units presented in the time-line view; and
a display in communication with the processing unit that presents a combined time-line and communication view.

29. The digital device of claim 28, wherein the processing unit drives the display to provide for a graphical representation of incoming digital communication quantity in relation to the time units presented in the time-line view.

30. The digital device of claim 28, wherein the processing unit drives the display to provide for a graphical representation of outgoing digital communication quantity in relation to the time units presented in the time-line view.

31. The digital device of claim 29, wherein the processing unit drives the display to provide for a graphical representation of outgoing digital communication quantity in relation to the time units presented in the time-line view.

32. The digital device of claim 28, wherein the processing unit drives the display to provide for graphically distinguishing between digital communications of a chosen communication characteristic.

33. The digital device of claim 32, wherein the chosen communication characteristic is further defined as communication type.

34. The digital device of claim 28, wherein the processing unit drives the display to provide for representing a predetermined relationship between a selected digital communication and one or more related digital communications.

35. The digital device of claim 34, wherein the predetermined relationship iis determined by analyzing metadata information associated with the digital communications.

36. The digital device of claim 35, wherein the predetermined relationship is chosen from the group consisting of communication history, editing history, communication originator, communication author, communication title, and communication topic.

37. The digital device of claim 28, wherein the processing unit is further capable of generating a preview view that displays at least a portion of a digital communication selected from the communication view and wherein the display presents a combined time-line, highlight, and communication view.

38. A digital device, the device comprising:
a processing unit capable of generating a time-line view that segments time into time units, and further capable of generating a relational view that represents a predetermined relationship between a selected digital communication and one or more related digital communications in relation to the time units presented in the time-line view; and
a display in communication with the processing unit that presents a combined time-line and relational view.

39. The digital device of claim 38, wherein the processing unit drives the display to represent the predetermined relationship on the display by highlighting the selected digital communication and the one or more related digital communications.

40. The digital device of claim 38, wherein the processing unit drives the display to represent the predetermined relationship on the display by providing for one or more connector lines between the selected digital communication and the one or more related digital communications.

41. The digital device of claim 38, wherein the predetermined relationship is further defined as chosen from the group consisting of communication history, editing history, communication author, communication sender, communication title and communication topic.

42. A method for providing a communication view of digital communication history in a digital device, the method comprising the steps of:
defining a time span and time units within the time span;
determining a quantity of digital communications that are associated with the defined time units; and
providing the communication view that graphically represents the quantity of digital communications that are associated with the time units.

43. The method of claim 42, wherein the step of determining a quantity of digital communications that are associated with the defined time units further includes analyzing metadata information associated with the digital communications to determine the quantity of digital communications associated with the defined time units.

44. The method of claim 42, further comprising the steps of:
defining a digital communication characteristic;
determining a quantity of digital communications that include the digital communication characteristic in association with the defined time units; and
providing a communication view that graphically represents the quantity of digital communications, by digital communication characteristic, that are associated with the time units.

45. The method of claim 44, wherein the step of defining a digital communication characteristic further comprises the step of defining the digital communication characteristic as communication type.

46. A method for providing a relational view of related digital communications in a digital device, the method comprising the steps of:
providing for a time-line view that defines a time span and time units within the time span;
representing a plurality of digital communications in the timeline view;
selecting a first digital communication from the timeline view; and
indicating, in the timeline view, one or more digital communications that are related to the first digital communication by a predetermined relational characteristic.

47. The method of claim 46, wherein the step of representing a plurality of digital communications in the timeline view further comprises the step of analyzing metadata information associated with the plurality of digital communications to determine a time associated with the communication.

48. The method of claim 46, wherein the step of representing a plurality of digital communications in the timeline view further comprises representing, in thumbnail format, a plurality of digital communications in the timeline view.

49. The method of claim 46, wherein the step of representing a plurality of digital communications in the timeline view further comprises representing, in topographic representation, a plurality of digital communications in the timeline view.

50. The method of claim 46, wherein the step of representing a plurality of digital communications in the timeline view further comprises representing a plurality of digital communications in the timeline view, wherein the plurality of digital communications relate to a chosen parameter of interest.

51. The method of claim 50, wherein the chosen parameter of interest is further defined as chosen from the group consisting of an individual, a group of individuals, a location and a communication topic.

52. The method of claim 46, wherein the step of selecting a first digital communication from the timeline view further comprises the step of searching for the first digital communication with a search query.

53. The method of claim 46, wherein the step of selecting a first digital communication from the timeline view further comprises the step of selecting by mouse-like cursor activation the first digital communication.

54. The method of claim 46, wherein the step of selecting a first digital communication from the timeline view further comprises the step of highlighting the selected first digital communication in the time-line view.

55. The method of claim 46, wherein the step of indicating, in the timeline view, one or more digital communications that are related to the first digital communication by a predetermined relational characteristic further comprises highlighting, in the timeline view, one or more digital communications that are related to the first digital communication by a predetermined relational characteristic.

56. The method of claim 46, wherein the step of indicating, in the timeline view, one or more digital communications that are related to the first digital communication by a predetermined relational characteristic further comprises connecting via connector lines, in the timeline view, one or more digital communications that are related to the first digital communication by a predetermined relational characteristic.

57. The method of claim 46, wherein the step of indicating, in the timeline view, one or more digital communications that are related to the first digital communication by a predetermined relational characteristic further defines the predefined relational characteristic as chosen from the group consisting of communication history, edit history, communication author, communication sender, communication title and communication topic.
